(19) United States
(12) Patent Application Publication
(10) Pub. No.: US 2026/0103584 A1
(43) Pub. Date: Apr. 16, 2026

(54) Halogenated Polyethylene And Ethylene Polymer Blends

(71) Applicant: Gates Corporation, Denver, CO (US)

(72) Inventors: Mathew Thomas, Lalru (IN); Thomas S. MOSS, III, Englewood, CO (US); Charles Ochoa, Columbia, MO (US)

(73) Assignee: Gates Corporation, Denver, CO (US)

(21) Appl. No.: 19/116,082

(22) PCT Filed: Sep. 27, 2023
(86) PCT No.: PCT/US2023/075242

§ 371 Date: Mar. 27, 2025

Related U.S. Application Data
(60) Provisional application No. 63/377,314, filed on Sep. 27, 2022.

(51) Int. Cl. C08L 19/00; C08K 3/04; C08K 3/36; C08K 5/14; C08L 13/00

(52) U.S. Cl. CPC C08L 19/006; C08K 3/04; C08K 3/36; C08K 5/14; C08L 13/00

(57) ABSTRACT

A rubber composition having a blend of ethylene polymers, particularly halogenated and non-halogenated ethylene polymer. The composition has the halogenated ethylene as 25-50 wt.-% of the total composition. In some embodiments, the non-halogenated ethylene polymer is an ethylene acrylic elastomer. The composition can include an organic peroxide or other accelerator. The rubber composition is useful for synchronous belts having moderate to high temperature resistance, good fuel resistance, flexibility down to −40° C. and high structural integrity. Additionally, the rubber composition allows reduction in the amount of fossil fuel derived reinforcing materials such as carbon black.

### TECHNICAL FIELD

The present application relates to compositions, particularly, rubber compositions, for use in flexible belts, such as synchronous belts having moderate to high temperature resistance, good oil resistance, flexibility down to −40° C. and high structural integrity.

### BACKGROUND

HNBR, a hydrogenated version of NBR rubber, is a synthetic rubber with very good temperature resistance and excellent oil resistance and which is widely used in synchronous belt compounds to meet application requirements.

Alternative materials are desired, which meet synchronous belt application requirements, including temperature resistance and oil resistance.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

The present disclosure is directed to a rubber composition having a polymer blend of ethylene terpolymers, particularly, a composition including a halogenated polyethylene. The composition has the halogenated polyethylene as 25-50 wt.-% of the total composition. In some embodiments, the halogenated polyethylene is a chlorinated polyethylene rubber. In some embodiments, the ethylene polymer is an ethylene acrylic elastomer. In some other embodiments, the ethylene polymer is EPDM rubber (which is a well-known rubber made from ethylene, propylene, and a diene comonomer that enables crosslinking via sulfur vulcanization). The composition can include an organic peroxide or other accelerator.

The rubber composition is useful for synchronous belts having moderate to high temperature resistance, good oil resistance, flexibility down to −40° C. and high structural integrity. Additionally, the rubber composition allows reduction in the amount of reinforcing material such as carbon black while maintaining the required properties for synchronous belts.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following FIGURES, wherein like reference numerals refer to like parts throughout the various views unless otherwise specified.

FIG. 1 is a perspective view of an example belt made with a composition of the present disclosure.

### DETAILED DESCRIPTION

As indicated, the present disclosure is directed to a rubber composition having a polymer blend of at least two ethylene polymers, with one of the polymers a halogenated polyethylene, particularly, the composition having a halogenated ethylene polymer, such as a polyethylene rubber, at 25 to 50 wt.-% of the total blend and the ethylene polymer at 10 to 30 wt.-% of the total blend, with the remainder being ingredients such as activators, fillers, curing agents, reinforcing materials, antidegradants (e.g., antioxidants, UV stabilizers), plasticizers, antistatic agents, colorants, processing aids, homogenizers, coagents, catalysts, and the like.

The composition can be organic peroxide cured or accelerator cured. The cured composition can have a minimum Mooney viscosity less than 60MU when tested at 133° C. This composition has a superior adhesion strength, with a tensile strength more than 18 MPa and temperature resistance up to 135° C. with retention of physical properties. The cured composition has a volume swell below 20% in IRM 901 oil at 135° C. for 168 hours; hence the composition has good oil resistant at high temperature. Additionally, the cured composition remains flexible at −35° C.

In the following description, reference is made to the accompanying drawing that forms a part hereof and in which is shown by way of illustration at least one specific implementation. The following description provides additional specific implementations. These embodiments are disclosed in sufficient detail to enable those skilled in the art to practice the invention. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the FIGURES, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

The present disclosure is directed to a rubber composition having a polymer blend of at least two ethylene polymers, with one of the polymers a halogenated ethylene; particularly, the composition having a halogenated ethylene rubber at 25 to 50 wt.-% of the total blend, in some embodiments 30 to 40 wt.-%, and a non-halogenated ethylene polymer at 10 to 30 wt.-% of the total composition, with the combined halogenated ethylene polymer and non-halogenated ethylene polymer forming 30 to 75 wt.-% of the total composition, in some embodiments 40 to 70 wt.-%. A chlorinated polyethylene rubber is an example of a suitable halogenated ethylene polymer. Examples of suitable non-halogenated ethylene polymers include EPDM rubber (which is a well-known rubber made from ethylene, propylene, and a diene comonomer that enables crosslinking via sulfur vulcanization), and ethylene acrylic polymers or elastomers. In some embodiments, the composition includes an organic peroxide or other accelerator to add in curing. Also in some embodiments, the composition includes a non-conjugated diene, at less than 15 wt.-% of the ethylene polymer weight.

The rubber composition is well suited for use in synchronous belts for automotive and industrial applications, as the cured composition has moderate to high temperature resistance, good oil resistance, flexibility down to −40° C. and high structural integrity.

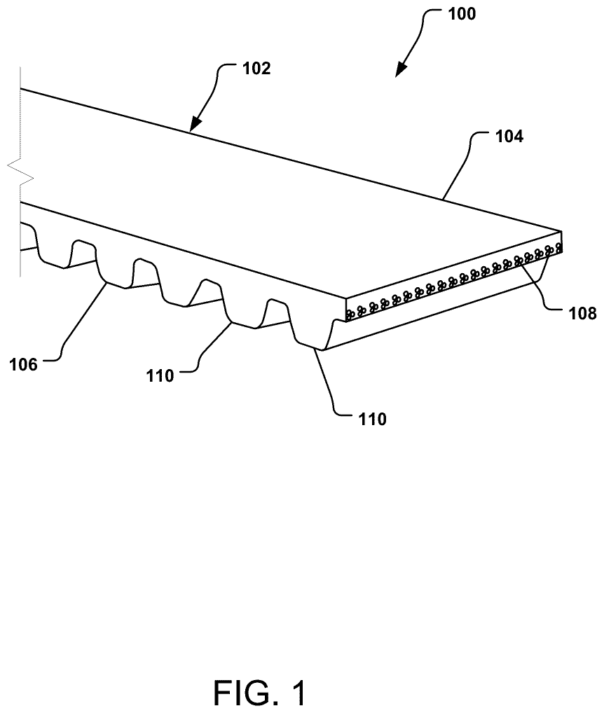

FIG. 1 shows a generic belt 100 having a body 102 formed of a flexible material having a back side 104 and a front side 106 with a plurality of load carrying cords 108 within the body 102, the particular cords 108 bound in triplicate bundles although in other embodiments the cords 108 may be single cords or otherwise bundled. The cords 108 may be, e.g., carbon cords, polymeric cords (e.g., polyester, aramid), fiberglass cords, etc. Defined in the front side 106 are a plurality of teeth 110; trapezoidal teeth are depicted in this embodiment of FIG. 1 but the tooth shape is not limited thereto and can take any shape that is compatible with a sprocket, gear or other toothed wheel. Each individual tooth 110 extends perpendicular to the longitudinal length of the belt 100 so that the plurality of teeth 110 run along or around the length of the belt 100. In use, the teeth 110 on the front side 106 are in contact with a drive mechanism, e.g., a toothed gear or sprocket. Although not seen in FIG. 1, the belt 100 is an endless belt, having the form of a loop with no beginning and no end.

The resulting blended composition of halogenated and non-halogenated ethylene polymers has the desirable balance of temperature resistance and ageing, ozone resistance, and solvent resistance. The composition is also sufficient flexibility at temperatures as low as −40° C., which is a general requirement for synchronous belts for automotive and industrial applications. The composition also exhibits excellent adhesion when compounded with selected bonding agents.

The halogenated ethylene polymer may include, e.g., chlorine (chlorinated), fluorine (fluorinated), and/or bromine (brominated). Examples of suitable halogenated ethylene polymers include chlorinated polyethylene rubber, polytetrafluoroethylene (PTFE), ethylene tetrafluoroethylene (ETFE), fluoroethylene vinyl ether (FEVE), fluorinated ethylene propylene (FEP), ethylene chlorotrifluoroethylene (EDTFE), and polychlorotrifluoroethylene (PCTFE).

Non-halogenated ethylene polymers suitable for blending with the halogenated ethylene include ethylene acrylic elastomer, EPDM, ethylene propylene elastomer (EPM), ethylene butene (EBM), ethylene pentene, and ethylene octene (EOM).

The selection of polymer grade affects the blended compound flow characteristics. High molecular grades, having higher Mooney viscosity, are not desirable for synchronous belts for automotive application due to poor flow and hence poor belt tooth formation, but the final cured material (e.g., the vulcanizate) has a superior physical property such as tensile strength, modulus and elongation. On the other hand, low molecular weight grades promote flow but the blended vulcanizate may not possess sufficient physical strength. There are many commercially available ethylene polymers, both halogenated and non-halogenated grades, with different molecular weights (e.g., Mw and Mn). These can be characterized by the Mooney viscosity (ML 1+4 at 100° C.) of the polymer which ranges from 30 to 90 MU.

The amount of ethylene polymer, both halogenated and non-halogenated ethylene polymers, is from 30 wt.-% to 75 wt.-% of the total weight of the raw ingredients that form the uncured blended composition, with the halogenated being 25 to 50 wt.-% of the total and the non-halogenated ethylene polymer being 10 to 30 wt.-% of the total. In some embodiments, the ethylene polymers are from about 40 wt.-% to 70 wt.-% of the total weight of the raw ingredients, in other embodiments about 45-60 wt.-%.

The weight ratio of the halogenated ethylene and the non-halogenated ethylene is from 3:1 to 1:1; in some embodiments, the halogenated and the non-halogenated are present at a weight ratio of about 2:1.

EPDM is a terpolymer of ethylene and propylene with a saturated polymer backbone and a saturated non-conjugated diene monomer as well as ethylene-propylene copolymer. Examples of diene monomers present in EPDM are dicyclopentadiene (DCPD), ethylidene norbornene (ENB), 1,4 hexadiene and methylidene norbornene.

EPDM is typically about 30% to about 80 wt.-% ethylene and about 0% to about 15% non-conjugated diene. Typically, the diene content can be identified by iodine numbers of about 5 to about 30. The Mooney viscosity (ML 1+4 at 125° C.) is typically about 40 to about 100 MU. Above 70 wt.-% ethylene, the EPDM polymer exhibits crystalline characteristics.

In addition to the halogenated polyethylene polymer (rubber) and the non-halogenated ethylene polymer, the blended composition may include additional rubber stock including, but not limited to, styrene-butadiene rubber (SBR), chloroprene rubber (CR), nitride butadiene rubber (NBR), hydrogenated nitrile butadiene rubber (HNBR), and fluoroelastomers (e.g., FKM).

The rubber stock (halogenated polyethylene, non-halogenated polyethylene, and any other) is often in the form of a solid powder, pellet, bale or block, although in some embodiments may be a liquid or semi-liquid.

As indicated above, the blended composition can include an organic peroxide or other accelerator to facilitate curing of the blended composition. Various types of organic peroxides can be used with the blended composition. Organic peroxides undergo decomposition at a certain temperature and produces radicals that initiate the cross-linking reaction in the compound. One particular example of an organic peroxide for use with polyethylene is a,a-bis (t-butylperoxy) diisopropyl-benzene. In some embodiments, the total amount of organic peroxide is less than about 3 wt.-% of the raw ingredients, in other embodiments less than about 2.5 wt.-% of the raw ingredients.

Polymer compositions cured with organic peroxides exhibit higher thermal resistance due to the formation of C—C cross links between the polymer chain. In contrast, sulfur cured polymers form C—S—C or C—(S)x-C bonds. Formation of mono sulfidic (i.e., C—S) bonds or poly sulfidic bonds (i.e., S—S) bonds leads to inferior thermal resistance of the polymer. The C—C bond energy (346 k J/mol) is higher than both C—S(272 k J/mol) and S—S(226 k J/mol) bond energy; this reflects in the higher temperature resistance of peroxide cured vulcanizate.

The blended composition can include various additives such as activators, fillers, curing agents, reinforcing materials, antidegradants (e.g., antioxidants, UV stabilizers), plasticizers, antistatic agents, colorants, processing aids, homogenizers, coagents, catalysts, and the like. Generally, the total wt.-% of additives is less than 75 wt.-% of the raw ingredients of the total composition, in some embodiments less than 65 wt.-% or less than 50 wt.-%.

Examples of activators include stearic acid and zinc oxide.

Stearic acid is commonly a solid, available as flakes or pellets, with a specific gravity of about 0.85. Stearic acid includes an amount of iodine, typically no more than 10 wt.-%. The acid value ranges between 193 and 213. Zinc oxide is also a solid, e.g., a fine powder with a surface area of 4-6 m²/g, with a specific gravity of 5.6. Zinc oxide may have some impurities present therein; e.g., CuO<0.0005 wt.-%, MnO<0.0005 wt.-%, SiO2<0.02 wt.-% and/or water soluble salts<0.05 wt.-%. In some embodiments, the total amount of activator(s) is less than about 5 wt.-% of the raw ingredients, in some embodiments less than about 3 wt.-%. Long chain fatty (LCF) acids can be used as a homogenizer, and when combined with zinc oxide, can act as an activator.

Any suitable curing agent(s) or material can be used, with the agent facilitating or assisting during curing. Example curing agent(s) suitable include sulfur and peroxides. In some embodiments, the amount of curative used is less than about 8 wt.-% of the total weight of the raw ingredients, such as less than 5 wt.-%.

Silica may be added to provide greater tensile strength, higher modulus, reduced compression set, and increased abrasion resistance to the blended composition. Silica is typically a solid, e.g., powder, and may be treated or untreated. The surface area of silica is typically between 120-200 m²/g. An example treated silica, having 5-8 wt.-% organosilane treatment, has a specific gravity of 1.9-2.0. This example silica has a volatile content of 3-5%, and a pH value between 6-8. The organosilane is a trialkoxysilane type. Because of this, the treated silica material has low moisture absorption and significantly low volatile formation during mixing and processing. In some embodiments, the total amount of silica is about 10 to 35 wt.-% of the raw ingredients.

Carbon black and/or graphite can be used as a filler in rubber compounds. Examples of other fillers include metal oxides such as aluminum oxide, magnesium oxide, and zinc oxide, clay, montorillonite clay, pulp, and mica.

The raw materials of the blended composition may include reinforcement material, such as chopped fiber segments, though other reinforcement material such as elongated segments, fibers, or nanotubes, can also be used. The reinforcement material, whether chopped or elongate, may be, e.g., aramid, polyester (PET), cotton, nylon, glass, carbon fiber cords, hybrid cords, metal, ceramic, and other plastic. The reinforcement material may be made from either organic or synthetic material, or a mixture of organic and synthetic materials.

The dimensions of the reinforcement material are generally not limited. In some embodiments, the chopped fibers have a high aspect ratio having a length in the range of from 0.2 mm to 3 mm. In some embodiments, the reinforcement materials (e.g., chopped fibers or elongate materials) have an aspect ratio of from 10 to 250. In some embodiments, the amount of reinforcement material is from 5 wt.-% to 30 wt.-% of the total weight of the raw ingredients. The reinforcement material is mixed with the raw ingredients and the resulting belt has the reinforcement materials homogeneously dispersed throughout the blended composition.

In some embodiments, the amount of filler (including any silica, carbon black or carbon reinforcing fibers) is from 5 wt.-% to 45 wt.-% of the total weight of the raw ingredients, whereas in other embodiments the filler is from about 10 wt.-% to about 20 wt.-% of the total weight of the raw ingredients. The polymer blend of ethylene polymers allows a decrease in the amount of carbon reinforcing fibers or other carbon and increase in other fillers, while still obtaining acceptable properties for synchronous belts. In some embodiments, the ratio of silica to reinforcing carbon is 5:1 to 3:1, for example, about 4:1.

Polymers, in general, are subject to degradation when exposed to different types of environmental factors, factors including oxygen, heat/temperature, UV light, weathering, catalytic degradation due to heavy metal ions, dynamic fatigue, etc. The failures observed in rubber compounds due to environmental degradation include loss of elasticity and tensile strength, formation of crazed surface, and appearance of cracks. The presence of unsaturation in a polymer can increase the tendency of failure due to heat ageing, due to the allylic C—H bond in an unsaturated chemical structure. The bond energy of allylic C—H is weakest among different type (primary, secondary, tertiary) of C—H bonds. This factor promotes the formation of free radicals and peroxy radicals in the presence of oxygen and heat and causes chain scission. Once the polymer main chain is broken, the compound starts to lose its physical and mechanical strength and starts to degrade. Antioxidants acts as a radical trap; they scavenge radicals to stop polymer chain scission and enhance the service life of the resulting product.

An antioxidant that can be used in rubber compounds is a polymerized quinoline derivative, 1,2-dihydro-2,2,4-tri-methylquinoline. Another antioxidant is a condensate of alkylated imidazole and diarylamine or ketone, and another is a condensate of mercaptobenzimidazole and diphenyleamine/acetone; these are strong non staining antioxidants for natural and synthetic rubber and offer extremely good temperature and flex protection at elevated temperatures.

Plasticizers can be added to elastomeric compounds for various reasons, such as increasing softness or flexibility, lowering the glass transition temperature, reducing crystallization, increasing dispersion, or lowering the cost of the compound. Common plasticizers used in elastomer compounds are mineral oils and esters such as phthalates, sebacates, and adipates.

Di-alkyl ester and di octyl adipate (DOA) are highly efficient plasticizers that can be used to impart excellent low temperature flexibility and resistance to impact to the resulting compound. In addition to their high efficiency and contribution to the low temperature properties, they are chemically stable and resistant to discoloration on extended exposure to temperature and ultraviolet light. The combination of low viscosity and efficiency provide excellent dry blending and processing characteristics.

Microcrystalline wax can be added as a physical antiozonant. The polymer chains containing double bonds are vulnerable to ozonolysis reaction and chain scission when in the presence of ozone. Microcrystalline wax provides a shielding layer or barrier over the compound and protects it from degradation because of chain scission.

Modified resorcinol, which is a resorcinol formaldehyde homopolymer resin modified with a selected group, can be used as a precondensed dry bonding agent; chemically, it is a resorcinol formaldehyde homopolymer resin modified with a selected group. Modified resorcinol facilitates the bonding of the blended composition.

Metallic acrylates such as zinc dimethacrylate can be used to boost the physical and mechanical properties of the compound and acts as a coagent. In the presence of organic peroxide, metallic coagents form ionic bonds and improves tear strength, modulus, and flex resistance of the compound.

Modified polybutadiene (with maleic anhydride) can be used as a bonding promoter in peroxide cured vulcanizates. Chemically, it is a low molecular weight, low vinyl butadiene functionalized with maleic anhydride. The anhydride functionality can react with epoxy, amine, and hydroxyl groups, enabling the creation of unique adhesives, sealants, encapsulants, and coatings. It also improves compatibility of the non-polar elastomer such as EPDM and increases the adhesion of peroxide cured elastomers to polyester, aramid or metal substrates.

A substituted phenolic derivative such as 2,6-di-tertiary-butyl-N,N-dimethylamino-P-cresol can be used as a scorch inhibitor for peroxide cured systems. It initially forms an adduct to trap the radical from the peroxide and affects the processing and flow time to the compound.

Above elastomers (the ethylene polymers) and any other ingredients can be blended by conventional rubber blending methods. In some embodiments, the mixing is generally carried out using an industrial mixer, such as a Banbury mixer, to mix together all raw ingredients; however, other mixing techniques and methods can be used. For example, roll mills and internal mixers can be used. In some embodiments, the individual raw ingredients are added into the mixer in a specific sequence to ensure sufficient incorporation and dispersion of the raw ingredients. In some embodiments, certain raw ingredients can be mixed together prior to being added in sequence into the mix.

Table 1 provides example ingredient ranges for blended compositions according to this disclosure.

TABLE 1

| | Option | Option |
|---|---|---|
| | #1 | #2 |
| Ingredient | wt.-% | wt.-% |
| Halogenated polyethylene rubber | 25-50 | 25-50 |
| Non-halogenated ethylene acrylic rubber | 10-30 | 10-30 |
| Semi reinforcing black | 2.5-5 | 3-6 |
| Precipitated silica (BET Surface Area - 165 m²/g) | 7-12 | 10-16 |
| Treated silica | 7-12 | 10-16 |
| Ester-type plasticizer | 0-2 | 0-1 |
| Long chain fatty acid (C15-C20) | 0-2 | 0-1 |
| Di octyl adipate | 0-1 | 0-1 |
| Metal oxide | 0-5 | 0-2 |
| Stearic acid | 0-1 | 0-1 |
| Zinc oxide | 0-2.5 | 0-3 |
| Polymerized quinoline derivative (antioxidant) | 0-2 | 0-1 |
| 1,2-dihydro-2,2,4-tri-methylquinoline (antioxidant) | 0-1 | 0-1 |
| Alkylated imidazole and diarylamine or ketone | 0-2 | 0-1 |
| (antioxidant) | | |
| Alkylated mercaptobenzimidazole & diphenylamine/ | 0-1 | 0-1 |
| acetone condensate (antioxidant) | | |
| Zinc dimethacrylate | 0-5 | 0-2 |
| Modified resorcinol | 0-5 | 0-3 |
| Liquid modified polybutadiene | 0-5 | 0-2 |
| a,a-bis (t-butylperoxy) diisopropyl-benzene | 0-10 | 0-5 |
| 2,6-di-tertiary-butyl-N,N-dimethylamino-P-cresol | 0-0.5 | 0-0.25 |

For the ingredients provided above, the semi reinforcing black has a specific gravity of 1.8, DBP absorption 30-48 CC/100 g, iodine absorption 6-12 mg/g, maximum heat loss 1%, sieve residue in 325 mesh 0.1%, ash content less than 0.5% and pellet hardness of 30 g.

The precipitated silica has a specific gravity of 2.0 and appeared as a fine white odorless powder. BET surface area of silica is between 130-200 m²/g. Loss on drying (105° C., 2 hrs) is between 3-7%. Loss on ignition, on anhydrous basis (1000° C., 2 hours) is 6% max. The pH of 5% water slurry is in the range of 6-8, SiO2, hydrate % is minimum 87%, DBP absorption value is between 200-280 mL for 100 g.

The treated silica has a specific gravity of 1.9-2.0. The trialkoxysilane treatment content is between 5-8%. The volatile content in this treated silica is 3-5%, the pH value is between 6-8 and appears as a white powder. The specific surface area of the silica grade is between 120-150 m²/g.

The zinc oxide is an odorless white colored fine powder with a specific gravity of 5.6 and surface area of 4-6 m²/g. The grade has heat loss value of maximum 0.5% at 110° C. The ash content of the grade is 99%, wet sieve residue (% retained on #325 mesh) is not more than 0.05 and (% retained on #200 mesh) is less than 0.02. Presence of CuO is <0.0005%, MnO<0.0005%, SiO2<0.02% and water soluble salt<0.05%.

The resulting composition, from Table 1 or any described above, can be used to form a belt, such as a synchronous belt, e.g., for automotive uses.

### EXAMPLES

Objects and advantages of this disclosure are further illustrated by the following non-limiting examples. The particular materials and amounts thereof recited in these examples as well as other conditions and details, should not be construed to unduly limit this disclosure. Unless otherwise noted, all parts, percentages, ratios, etc. in the Examples and the rest of this disclosure are by weight.

### Example 1

The materials listed in Table 2, at the amounts listed, were used to prepare a composition according to this disclosure.

TABLE 2

| Ingredient | wt-% |
|---|---|
| Chlorinated polyethylene rubber | 32.5 |
| Ethylene acrylic rubber | 13.9 |
| Carbon black | 9.3 |
| Precipitated silica (BET Surface Area - 165 m²/g) | 12.1 |
| Treated silica | 8.4 |
| Magnesium oxide | 2.3 |
| Microcrystalline wax | 0.9 |
| Stearic Acid | 0.5 |
| Tri octyl tri-malliate | 11.6 |
| Epoxidized soybean oil | 2.3 |
| RF resin | 0.9 |
| Peroxide | 2.8 |
| Imide crosslinker | 1.9 |

Mixing of the ingredients were done in three stages. In the first stage, all materials excluding the curatives were charged in the intermix at an RPM between 10-20. Overall mixing time was between 8-12 minutes to a dump temperature of 150° C. In the second stage, the compound was again mixed to 150° C. for better dispersion and homogeneity. The peroxide curatives were added in the third stage of mixing, where the RPM was kept between 8-10 and the batch was dumped at 95° C.

The mixed stock was cured for 20 minutes at 180° C. using a hydraulic press.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “about” or “approximately.” At the very least, and not as an attempt to limit the application of the doctrine of equivalents to the claims, each numerical parameter recited in the specification or claims which is modified by the term “about” or “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed:

1. A synchronous belt formed from an uncured composition comprising halogenated polyethylene polymer and non-halogenated ethylene polymer, the halogenated polyethylene polymer and ethylene polymer present as 25 to 75 wt.-% of the uncured composition.

2. A belt formed from the uncured composition of claim 1, wherein the halogenated polyethylene polymer is present as 25 to 50 wt.-% of the uncured composition and the ethylene polymer is present as 10 to 30 wt.-% of the uncured composition.

3. The belt formed from the uncured composition of claim 1, wherein the halogenated polyethylene polymer is 30 to 40 wt.-% of the uncured composition.

4. The belt formed from the uncured composition of claim 1, wherein the halogenated polyethylene polymer is chlorinated.

5. The belt formed from the uncured composition of claim 1, the uncured composition further comprising organic peroxide.

6. The belt formed from the uncured composition of claim 1, wherein the ethylene polymer is an ethylene acrylic elastomer.

7. The belt formed from the uncured composition of claim 1, the uncured composition further comprising carbon reinforcing filler and silica.

8. The belt formed from the uncured composition of claim 7, wherein the silica is present at a level greater than the carbon reinforcing filler.

9. The belt formed from the uncured composition of claim 8, wherein the silica is present at a level of about 10 to 35 wt.-% of the uncured composition and the carbon reinforcing filler is present at a level of about 3 to 8 wt.-%.

10. The belt formed from the uncured composition of claim 8, wherein the silica is present in relation to the carbon reinforcing filler at a ratio of about 4:1.

11. The belt formed from the uncured composition of claim 1, wherein the belt has a tensile strength of 18 MPa or greater.

12. The belt formed from the uncured composition of claim 1, wherein the belt is readily flexible at −35° C.
